(19) United States
(12) Patent Application Publication
(10) Pub. No.: US 2018/0210569 A1
(43) Pub. Date: Jul. 26, 2018

(54) STORAGE AND CONTROL EXTERNAL TO A COMPUTER SYSTEM

(71) Applicant: Seagate Technology LLC, Cupertino, CA (US)

(72) Inventor: Bruno Jean MASSON, Cupertino, CA (US)

(21) Appl. No.: 15/417,140

(22) Filed: Jan. 26, 2017

(51) Int. Cl. G06F 3/0354; G06F 3/0346; G06F 3/01

(52) U.S. Cl. CPC G06F 3/03547; G06F 3/016; G06F 3/0346

(57) ABSTRACT

Provided herein are techniques related to storage and control external to a computer system. The computer system includes a display component. Physically separate from the computer system is an apparatus that includes a user input component and a data storage component. The user input component is configured to receive input that controls what is displayed at the display component. The computer system is configured to retrieve, from the data storage component, information to be displayed at the display component.

### BACKGROUND

Increasing processing power has been accompanied by an increasing amount of data to process. For example, screen resolutions have rapidly doubled from 2K to 4K, and the amount of data simultaneously displayed on a screen has exhibited a corresponding increase. In addition, users are rapidly accumulating more and more high definition content (e.g., photos and videos) to be viewed on such high resolution displays. As such, local storage has become inadequate for storing this ever-increasing amount of data. Accordingly, data is offloaded to external storage devices, but user experiences are adversely impacted by issues related to storing and retrieving large amounts of data. For example, cloud storage exposes the user experience to bottlenecks caused by network latency or other data retrieval issues. Compounding this problem is the tendency to maximize the size of display screens at the expense of adequate interfaces for communicating with other devices. Thus, external storage devices may be inaccessible when they unsuccessfully compete for limited communication interfaces.

### SUMMARY

Provided herein are techniques related to storage and control external to a computer system. The computer system includes a display component. Physically separate from the computer system is an apparatus that includes a user input component and a data storage component. The user input component is configured to receive input that controls what is displayed at the display component. The computer system is configured to retrieve, from the data storage component, information to be displayed at the display component. These and other features and advantages will be apparent from a reading of the following detailed description.

### BRIEF DESCRIPTION OF DRAWINGS

FIG. 1 illustrates a wired connection between a computer system and an external storage and control apparatus, according to one aspect of the present description.

FIG. 2 illustrates a rigid connection between a computer system and an external storage and control apparatus, according to one aspect of the present description.

FIG. 3 illustrates a wireless connection between a computer system and an external storage and control apparatus, according to one aspect of the present description.

FIG. 4 illustrates a wireless connection between a head-mounted computer system and an external storage and control apparatus, according to one aspect of the present description.

FIG. 5 illustrates an external storage and control apparatus that provides haptic feedback, according to one aspect of the present description.

FIG. 6 illustrates a flow diagram for providing storage and control external to a computer system, according to one aspect of the present description.

### DESCRIPTION

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “middle,” “bottom,” “beside,” “forward,” “reverse,” “overlying,” “underlying,” “up,” “down,” or other similar terms such as “upper,” “lower,” “above,” “below,” “under,” “between,” “over,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

An ever-increasing amount of data is rendered in each frame of content displayed on a screen. Thus, a positive user experience depends on quickly retrieving and processing large quantities of data. However, as data is increasingly offloaded to external storage devices, data transfer speeds have become bottlenecked by network quality of service issues. For example, if the external storage device is separated from the computer system by multiple interconnected networks, data retrieval is susceptible to latency, bandwidth, congestion, and/or other network-related issues. This is manifested as stutters, freezes, and/or other anomalies in streaming data.

Even if the external storage device shares a local connection with the computer system, the external storage device may compete with other devices for access to the computer system. For example, the computer system may be unable to adequately communicate (e.g., via Bluetooth) with more than one other device at a time. Such a case may occur when the external storage device competes with a wireless input device for the limited interfaces of the computer system. Thus, the external storage device may be unavailable to the computer system when the computer system is being used with the wireless input device. In addition, there may be limitations in the local connection. For example, a wireless connection or a cable connection may not be capable of passing the size of the data needed.

As a result of the foregoing, embodiments described herein combine an external storage device with an input device. For example, a computer system may communicate with a single apparatus that includes both a data storage component and a user input component. The user input component is configured to control the computer system. The data storage component is configured to store information that is retrieved and displayed by the computer system. Thus, the embodiments described herein relate to an external storage and control apparatus (hereinafter “ESC apparatus”) that shares a local connection with the computer system.

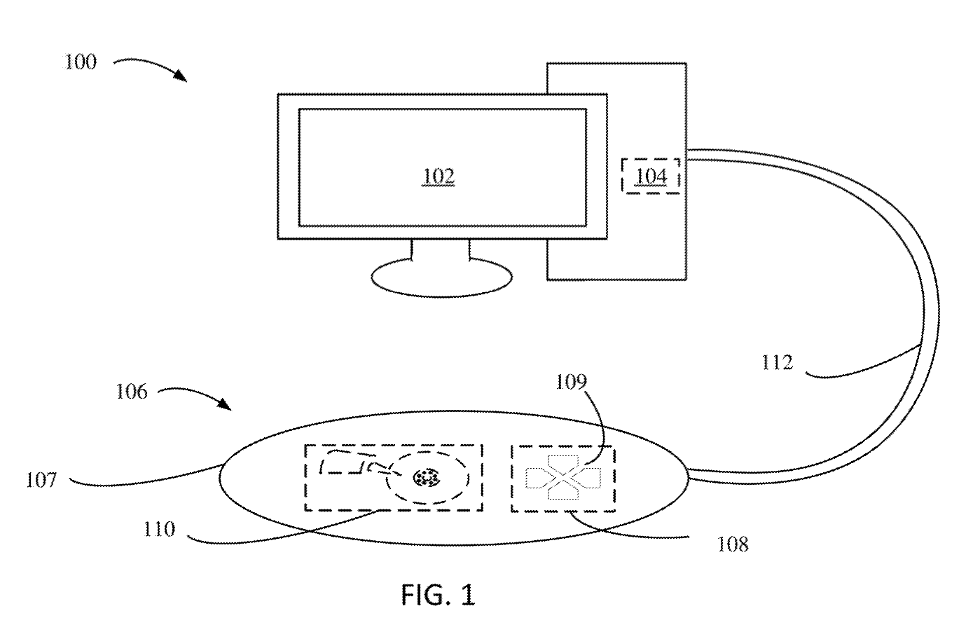

Referring to FIG. 1, a computer system 100 and an ESC apparatus 106 are illustrated according to one aspect of the present description. The ESC apparatus 106 is external to the computer system 100 and communicatively coupled to the computer system 100 through a wired connection 112, in the present embodiment. As a device external to the computer system 100, the ESC apparatus 106 is physically separate from the computer system 100. In other words, the computer system 100 will continue to operate even if the ESC apparatus 106 is disconnected from the computer system 100. As such, the ESC apparatus 106 is similar to other peripheral devices such as a keyboard, a mouse, a flash drive, and other corresponding peripheral devices.

The ESC apparatus 106 includes a user input component 108. The user input component 108 enables external control of the computer system 100. For example, the user input component 108 may include a button, an analog stick, a touchpad, a track ball, an optical sensor (e.g., a mouse device), a microphone (e.g. for voice control), an accelerometer, a gyroscope, and/or any other mechanism for controlling the computer system 100 from the ESC apparatus 106. More specifically, the user input component 108 receives user input and converts it into digital control data. Non-limiting examples of user input may include a depressing of a button, a movement of an analog stick, pressure at a region of a touchpad, a motion of the ESC apparatus 106, and/or any other manifestation of user intent. The digital control data is then transmitted from the ESC apparatus 106 to the computer system 100.

Accordingly, in various embodiments, the ESC apparatus 106 provides an alternative user interface for situations in which it is impracticable to provide user input directly at the computer system 100. For example, the computer system 100 may be a smart television that is located sufficiently far from a user that the user is unable to reach an interface of the computer system 100. As another example, the computer system 100 may be computing eyewear that is located sufficiently close to a user that the user is unable to see an interface of the computer system 100.

As previously discussed, in addition to the user input component, the ESC apparatus 106 also includes the data storage component 110. The data storage component 110 enables external storage for the computer system 100. For example, the data storage component 110 may include a magnetic storage (e.g. magnetic recording device) and/or a solid-state storage (e.g. solid-state recording device) that is external to the computer system 100. As such, the data storage component 110 may include a hard disk drive, a hybrid drive, a solid state drive, or other storage device to supplement the storage capacity of the computer system 100.

The data storage component 110 is configured to store information received from the computer system 100. For example, the data storage component 110 may be used to maintain a backup copy of information stored at the computer system 100. Additionally or alternatively, the data storage component 110 may be configured to provide supplemental storage for the computer system 100. In other words, the data storage component 110 may augment the storage capacity of the computer system 100. For example, to avoid exceeding the storage capacity of the computer system 100, information received by the computer system 100 may be offloaded to the data storage component 110.

Thereafter, the information may be retrieved on an “as needed” basis. For example, when a user wishes to interact with the information, the computer system 100 may request the information from the data storage component 110. In response, the data storage component 110 may send the information to the computer system 100.

The ESC apparatus 106 provides a locally connected storage option for situations in which Internet access is inadequate. For example, the computer system 100 may be a mobile computing device (e.g. battery based computing device) with a limited storage capacity due to its small physical size. Thus, the limited storage capacity may be quickly used up with a number of high resolution digital photographs and/or high resolution videos. However, network storage services may be unavailable or prohibitively slow in locations where network connectivity is poor or unavailable. In such situations, the ESC apparatus 106 enables continued storage and retrieval of high quality digital content.

In some embodiments, the ESC apparatus 106 includes a hand-held enclosure 107. The user input component 108 and the data storage component 110 are mounted within the hand-held enclosure 107. In the illustrated embodiment, the user input component 108 includes a set of directional buttons 109, and the data storage component 110 is a hard disk drive. However, it should be appreciated that the set of directional buttons 109 and the hard disk drive are provided by as non-limiting examples. Various embodiments may include any input device as the user input component 108 and any storage device as the data storage component 110.

In the illustrated embodiment, the ESC apparatus 106 does not include a display component. However, in some embodiments, the ESC apparatus 106 may include a display component (not shown). Example display components include a display screen, one or more indicator lights, and/or any other mechanism for providing visual feedback to a user.

As previously discussed, the ESC apparatus 106 is communicatively coupled to the computer system 100 based on a wired connection 112, in various embodiments. The wired connection 112 may include any of a variety of connectors. For example, the wired connection 112 may include a Universal Serial Bus (USB) connector, a Micro-USB connector, a thirty-pin dock connector, an eight-pin dock connector, a headphone jack, and/or any other connector suitable for bidirectional data transmission. The wired connection 112 enables both the user input component 108 and the data storage component 110 to use the same connector for communicating with the computer system 100.

FIG. 1 illustrates the computer system 100 as a desktop computer system. In the alternative, however, the computer system 100 may be a workstation, a laptop computer, a tablet computer, a smartphone, a smart television, a digital camera, a digital video camera, and/or any other device(s) with one or more processors 104 and a display component 102. The one or more processors 104 may include a central processing unit, a graphics processing unit, a digital signal processor, and/or any other integrated circuit. The display component 102 may include a display screen, a liquid crystal display, a light-emitting diode (LED) display, an organic LED display, a touchscreen, and/or any other mechanism for visually communicating information.

In some embodiments, the computer system 100 includes an operating system for managing the display component 102, the user input component 108, and the data storage component 110. In such embodiments, it is the computer system 100, not the ESC apparatus 106, that runs the user input component 108 and the data storage component 110. In other words, the ESC apparatus 106 may be a passive device that the computer system 100 controls.

For example, the operating system may enable the user input component 108 to be used for controlling what is displayed at the display component 102. More specifically, the one or more processors 104 of the computer system 100 may execute instructions causing the user input component 108 to receive user input, convert the user input into control data, and send the control data to the one or more processors 104. Based on processing the control data, the one or more processors 104 may modify what is displayed at the display component 102. Examples of modifying what is displayed include, without limitation, moving a cursor or otherwise navigating a display, selecting computer functions or otherwise interacting with displayed elements, and/or causing display of different information.

Additionally or alternatively, the operating system may enable the data storage component 100 to provide information for display at the computer system 100. More specifically, in response to receiving the control data, the one or more processors 104 may retrieve stored information from the data storage component 110. Subsequently, the one or more processors 104 may cause the stored information to be displayed at the display component 102. For example, after a user presses a right arrow button, the display component 102 may render the next image in a sequence of images stored in the data storage component 110.

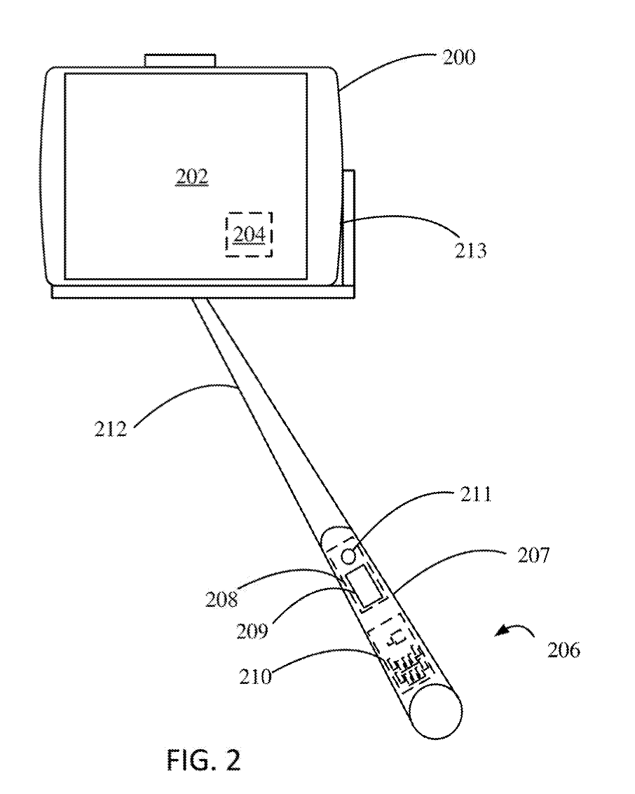

Referring to FIG. 2, a computer system 200 and an ESC apparatus 206 are illustrated according to one aspect of the present description. The computer system 200 and the ESC apparatus 206 are communicatively coupled based on a rigid connection 212, in the present embodiment. The rigid connection 212 is a wired connection, such as the wired connection 112 (see FIG. 1), that is enclosed in a rigid housing. In the illustrated embodiment, the rigid connection 212 is part of a “selfie stick” that enables remote interaction with the computer system 200. In the process of taking a “selfie” (e.g., a photograph of the user holding the rigid connection 212), direct interaction with the computer system 200 is difficult, if not impossible.

In combination with the rigid connection 212, the ESC apparatus 206 addresses this problem. Like the ESC apparatus 106 (see FIG. 1), the ESC apparatus 206 provides an external control mechanism. Although the ESC apparatus 206 is otherwise similar to the ESC apparatus 106 (see FIG. 1), some notable variations are illustrated in the present embodiment. The ESC apparatus 206 includes a hand-held enclosure 207 that forms the handle of the rigid connection 212. Furthermore, a user input component 208 is illustrated as including both a touchpad 209 and a button 211. Additionally, a data storage component 210 is illustrated as including a solid-state drive. It should be appreciated that the present embodiment is not limited to these variations and that different combinations of any number of different variations are possible.

The computer system 200 is illustrated as a tablet computer that includes a built-in display component 202 and one or more processors 204. Although the computer system 200 is otherwise similar to the computer system 100 (see FIG. 1), it should be noted that the computer system 200 is a mobile computing device having a limited number of physical interfaces for communicating with other devices. For example, the computer system 200 may only have a headphone socket and a Micro-USB socket. As such, users are faced with the difficult decision of selecting a very limited number of devices to connect to the computer system 200 at any one time.

For example, a user may wish to take a high resolution “selfie” using a tablet computer that has little capacity remaining in local storage. Thus, the user may wish to connect both an external storage device and an external input device to the tablet computer. However, the interface limitations of the tablet computer may preclude concurrent use of a separate external control device and a separate external storage device.

This problem can be addressed by including both the user input component 208 and the data storage component 210 in the ESC apparatus 206. Thus, the same interface of the computer system 200 may be used to communicate with both the user input component 208 and the data storage component 210. For example, both the user input component 208 and the data storage component 210 may communicate with the computer system 200 via a physical interface 213.

For the avoidance of doubt, it is reiterated that embodiments are not limited to the illustrated examples. To the contrary, any of a variety of different computer systems can be combined with any of a variety of different ESC apparatuses or components thereof. For example, the present embodiment may be practiced using a smartphone or a digital camera instead of a tablet computer. Additionally or alternatively, the user input component 208 may include a trackball or a wheel. Additionally or alternatively, the data storage component 210 may include a hard disk drive. Thus, the particular combination of devices that is used may vary from implementation to implementation.

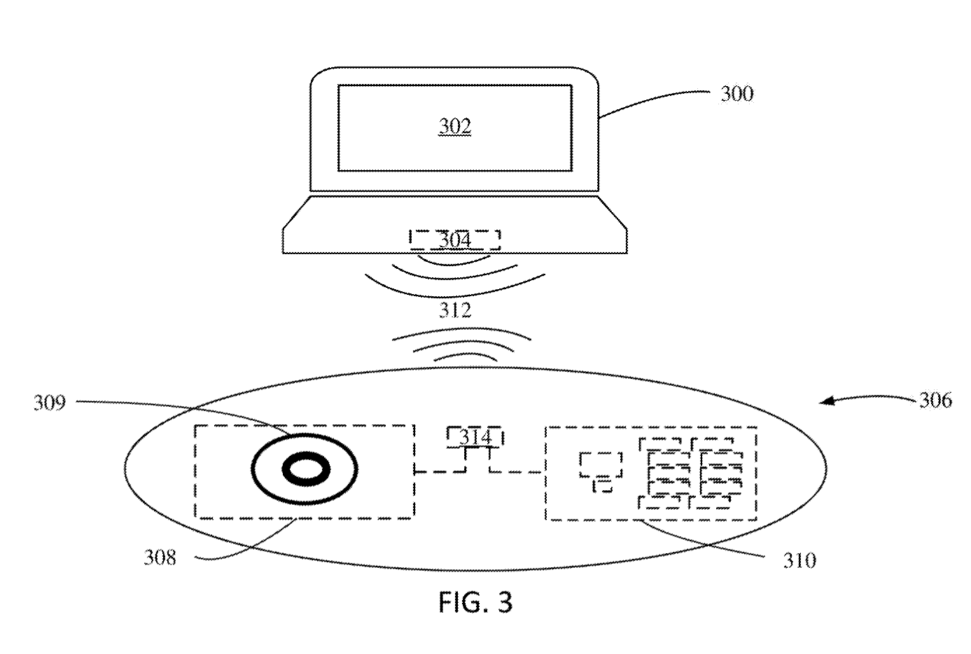

Referring to FIG. 3, a computer system 300 and an ESC apparatus 306 are illustrated according to one aspect of the present description. The computer system 300 and the ESC apparatus 306 are communicatively coupled via a wireless connection 312, in the present embodiment. The wireless connection 312 may be a Bluetooth connection, a Wi-Fi Direct connection, and/or any other connection based on radio frequency (RF) communications. Accordingly, the ESC apparatus 306 further includes one or more processors 314 that enable the wireless connection 312. For example, the one or more processors 314 may be coupled to an RF transceiver.

In various embodiments, the one or more processors 314 are coupled to each of the user input component 308 and the data storage component 310. In the illustrated embodiment, the user input component 308 includes a thumbstick 309. Additionally, the data storage component 310 is illustrated as including a solid-state drive. It should be appreciated that the illustrated embodiment is a non-limiting example, and that other combinations of input components and storage components are possible. For example, the user input component 308 may include both a button and a thumbstick, and the data storage component 310 may include a hybrid drive with both solid-state drive components and hard drive components.

As mentioned above, the ESC apparatus 306 is communicatively coupled to the computer system 300 based on the wireless connection 312. In the illustrated embodiment, the computer system 300 is a laptop computer having a display component 302 and one or more processors 304. Like the one or more processors 314, the one or more processors 304 may be coupled to an RF transceiver and/or otherwise enable the wireless connection 312. In various embodiments, the wireless connection 312 may be used with any computer system, including any of those described above.

For the avoidance of doubt, it is reiterated that embodiments are not limited to the illustrated examples. To the contrary, any of a variety of different computer systems can be combined with any of a variety of different ESC apparatuses or components thereof. For example, the present embodiment may be practiced using a tablet computer or a smart television instead of a laptop computer. Additionally or alternatively, the user input component 208 may include a touchpad or an accelerometer. Additionally or alternatively, the data storage component 210 may include a hard disk drive. Thus, the particular combination of devices that is used may vary from implementation to implementation.

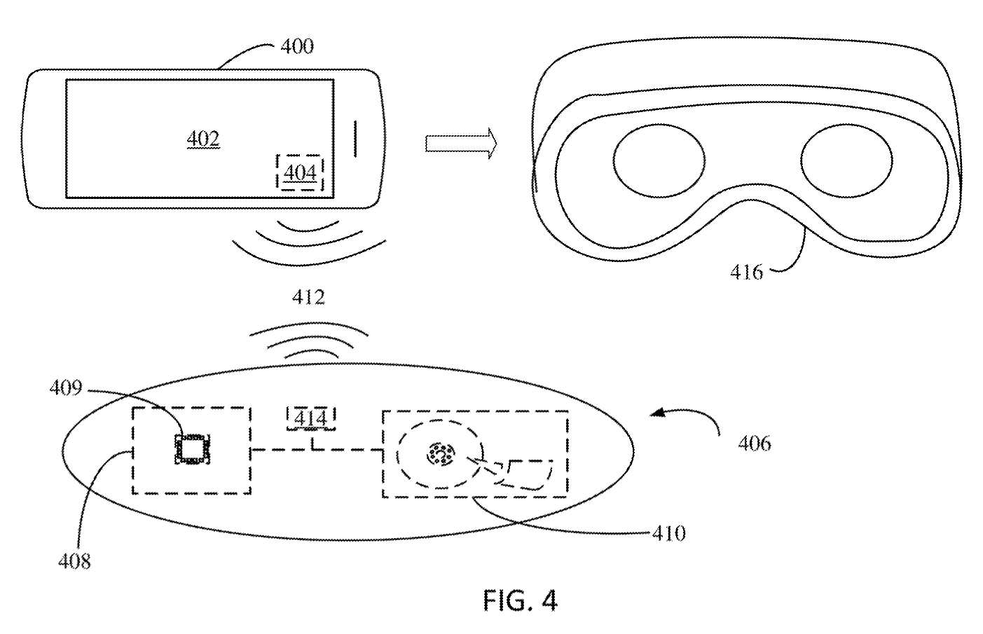

Referring to FIG. 4, a head-mounted computer system 400 and an ESC apparatus 406 are illustrated according to one aspect of the present description. The head-mounted computer system 400 and the ESC apparatus 406 are communicatively coupled via a wireless connection 412, in the present embodiment. Like the wireless connection 312, the wireless connection 412 enables remote interaction. In the illustrated embodiment, the remote interaction is between the ESC apparatus 406 and the computer system 400, which is mounted on, attached to, and/or otherwise combined with a headset 416. The headset 416 may render one or more user interfaces of the computer system 400 inaccessible. For example, the headset 416 may obstruct access to a touchscreen of the computer system 400. Additionally or alternatively, the headset 416 may position the computer system 400 in such a manner that makes it difficult to interact with one or more user interfaces. For example, the computer system 400 may be positioned so close to a user's eyes that the user is unable to comfortably and easily interact with the buttons of the computer system 400.

The ESC apparatus 406 enables external control of the computer system 400. In some embodiments, the ESC apparatus 406 includes a user input component 408 providing an alternative user interface that can be operated without a line of sight between the user and the user input component 408. In the illustrated embodiment, the user input component 408 is illustrated as including a microelectromechanical system gyroscope 409. However, the user input component 408 is not limited to this particular input device. For example, the user input component 408 may include a thumbstick or an accelerometer.

The ESC apparatus 406 also enables external storage for the computer system 400. In the present embodiment, the data storage component 410 is illustrated as including a hard disk drive. However, the data storage component 410 is not limited to this particular storage device. For example, the data storage component 410 may include a solid-state drive or a hybrid drive.

The ESC apparatus 406 also includes one or more processors 414 that are coupled to each of the user input component 408 and the data storage component 410. In some embodiments, the user input component 408 and the data storage component 410 are also coupled to each other. Such an arrangement may enable the user input component 408 and the data storage component 410 to communicate with each other. For example, in response to receiving user input, the user input component 408 may retrieve, from the data storage component 410, corresponding information to be displayed at the computer system 400.

It should be appreciated that the present embodiment may be practiced using any other combination or arrangement of input components, storage components, and or processor(s). For example, the present embodiment may be practiced using the ESC apparatus 306 (see FIG. 3). Thus, the present embodiment is not limited to the illustrated variations.

As mentioned above, the ESC apparatus 406 is communicatively coupled to the computer system 400 based on the wireless connection 412. In the present embodiment, the computer system 400 is illustrated as a smartphone that includes a built-in display component 402 and one or more processors 404. Although the computer system 400 is otherwise similar to any of the computer systems described above, it should be noted that the combination of the computer system 400 with the headset 416 yields computing eyewear, such as a pair of virtual reality and/or augmented reality goggles. Thus, the display component 402 becomes a head-mounted display component, which can make user interaction more difficult.

Thus, in some embodiments, an application program (not shown) may be installed on the computer system 400. For example, the application program may be a native mobile app. When the one or more processors 404 execute instructions of the application program, the user may be provided with an option to enter or exit a headset mode. When in the headset mode, the application program is synchronized for use with the user input component 408. When out of the headset mode, the application program may ignore some or all signals from the ESC apparatus 406, because the computer system 400 can be controlled directly.

For example, when in the headset mode, the ESC apparatus 406 can be used as an external input device to control what is displayed at the computer system 400. In contrast, when out of the headset mode, the computer system 400 may become unresponsive to the ESC apparatus 406, in various embodiments. Instead, the computer system 400 may be controlled directly via any of its user interfaces. In further embodiments, when out of the headset mode, the computer system 400 may become unresponsive to only the user input component 408 while maintaining connectivity and responsiveness to the data storage component 410. In still further embodiments, when out of the headset mode, the computer system 400 may maintain connectivity and responsiveness to both the user input component 408 and the data storage component 410.

For the avoidance of doubt, it is reiterated that the present embodiment is not limited to the illustrated examples. To the contrary, any of a variety of different computer systems can be combined with any of a variety of different ESC apparatuses or components thereof. For example, the present embodiment may be practiced using a tablet computer instead of a smartphone. Additionally or alternatively, the user input component 208 may include a thumb stick and/or a button. Additionally or alternatively, the data storage component 210 may include a solid-state drive. Thus, the particular combination of devices that is used may vary from implementation to implementation.

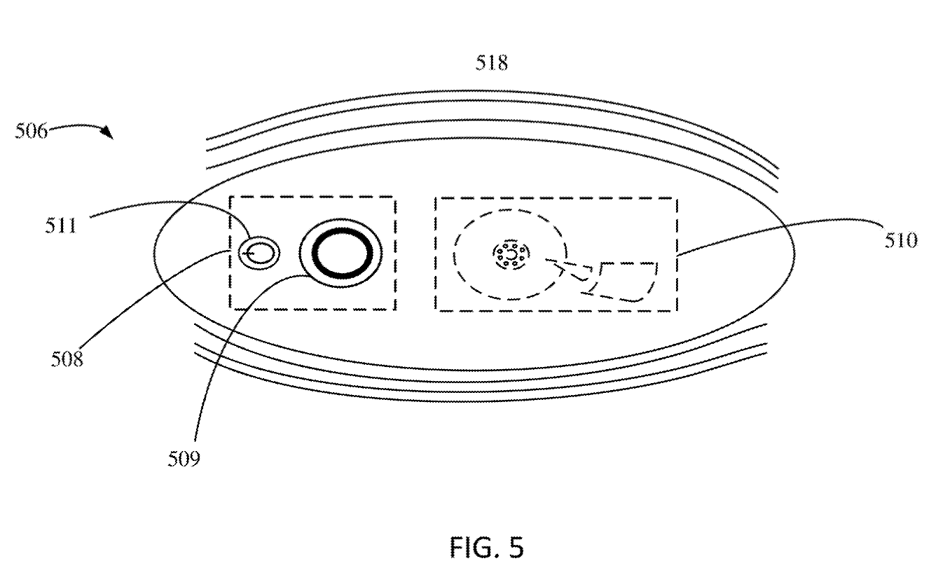

Referring to FIG. 5, an ESC apparatus 506 that provides haptic feedback 518 is illustrated according to one aspect of the present description. In the present embodiment, the ESC apparatus 506 includes a data storage component 510 that is illustrated as including a hard disk drive. The data storage component 510 may be configured to provide the haptic feedback 518 based on a haptic feedback engine and/or moving parts of the data storage component 510. For example, the haptic feedback 518 may be provided as a combination of the forces associated with a rotating disk and a moving read/write arm.

The haptic feedback 518 may be manifested as forces, vibrations, and/or any other tactile response to user input. For example, a user input component 508 may transmit, to a computer system, control data that causes selection of a display element. In response to receiving the control data, the computer system may cause the data storage component 510 to produce the haptic feedback 518. Examples of the haptic feedback 518 include, without limitation, one or more vibrations when selecting a display element, a locking feeling when navigating onto a display element, and/or a resistance force when navigating off of a display element.

In some embodiments, the moving parts of the data storage component 510 may be shared with the user input component 508. For example, a rotating disk of the data storage component 510 may also be used as a gyroscope. In addition, a gyroscope may also be included in the ESC apparatus 506. It is understood that in embodiments including a gyroscope, the gyroscope provides feedback to the user instead of the data storage component 510. In further embodiments, the gyroscope provides feedback to the user in addition to the data storage component 510. In such embodiments, the user input component 508 may include at least part of the data storage component 510. For example, the user input component 508 may include inner and outer gimbals that surround the rotating disk of the data storage component 510.

In the illustrated embodiment, the user input component 508 includes multiple input mechanisms. More specifically, the user input component 508 is illustrated as including both a thumbstick 509 and a power button 511 for controlling another apparatus, such as any of the computer systems described above. However, the present embodiment may be practiced with any number of different variations.

For example, the user input component 508 may include directional buttons. Additionally or alternatively, the data storage component 510 may include a hybrid drive. Additionally or alternatively, the ESC apparatus 506 may be communicatively coupled to another device based on a wired connection or a wireless connection. Thus, the present embodiment is not limited to the illustrated examples.

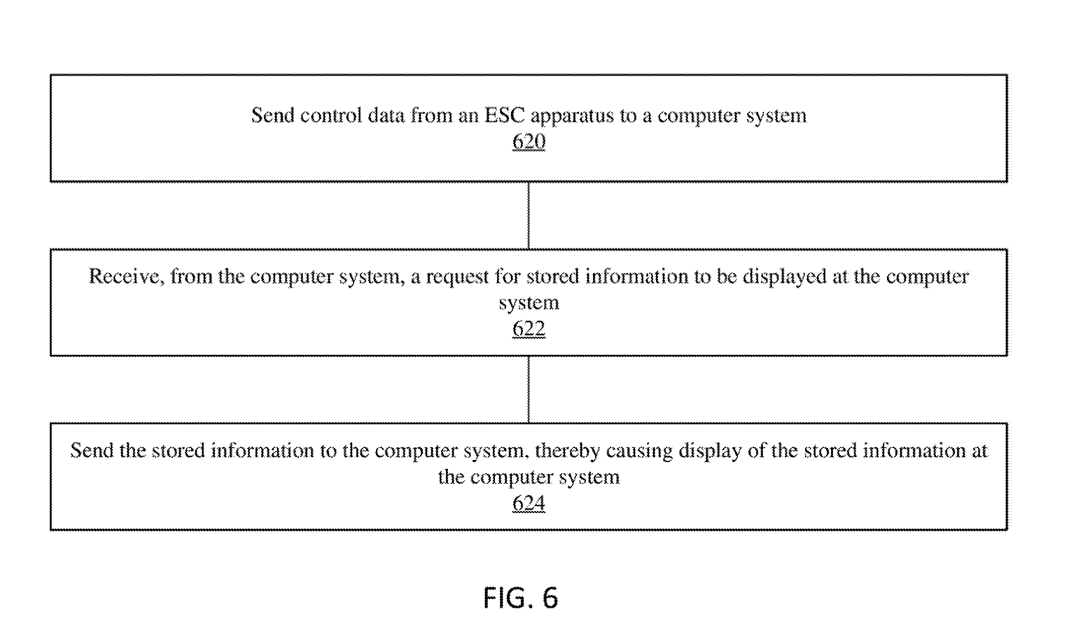

Referring to FIG. 6, a flow diagram for providing storage and control external to a computer system is illustrated according to one aspect of the present description. The example process of FIG. 6 may be performed using any ESC apparatus, including any of the ESC apparatuses described above.

At a block 620, an ESC apparatus sends control data to a computer system. For example, in FIG. 1, the ESC apparatus 106 sends control data to the computer system 100 via the wired connection 112. User input is received at a user input component of the ESC apparatus, and the user input is converted into the control data. For example, in FIG. 2, the user input component 208 receives user input in the form of pressure at one or more regions of a touchpad, which may include a piezoelectric material that generates a set of electric charges in response to the pressure. This set of electric charges may be represented as digital data that indicates how a user wishes to interact with the computer system 200.

In some embodiments, the control data may be transmitted as electromagnetic waves. For example, in FIG. 3, the ESC apparatus 306 includes the one or more processors 314 that convert the control data into electromagnetic waves, which are transmitted via the wireless connection 312. Furthermore, the control data may be received as electromagnetic waves. For example, in FIG. 4, the computer system 400 includes the one or more processors 404 that convert the electromagnetic waves into a digital format.

As will be described in greater detail below, in response to receiving the control data, the computer system may attempt to fetch display data from the apparatus. The display data includes information to be displayed at a display component of the computer system.

At a block 622, the apparatus receives a request for the display data from the computer system. For example, in FIG. 1, the computer system 100 sends the request to the ESC apparatus 106 via the wired connection 112. A data storage component of the apparatus stores the display data. For example, in FIG. 2, the ESC apparatus 106 includes the data storage component 210 that stores the display data. Thus, the data storage component 210 receives the request.

In some embodiments, the request may be transmitted as electromagnetic waves. For example, in FIG. 3, the computer system 300 includes the one or more processors 304 that convert the request into electromagnetic waves, which are transmitted via the wireless connection 312. Furthermore, the request may be received as electromagnetic waves. For example, in FIG. 4, the ESC apparatus 406 includes the one or more processors 414 that convert the electromagnetic waves into a digital format.

At a block 624, the apparatus sends the display data to the computer system. For example, in FIG. 1, the data storage component 110 retrieves and transmits the display data to the computer system 100 via the wired connection 112. In response to receiving the display data, one or more processors of the computer system may execute instructions causing a display component to render the display data. For example, in FIG. 2, the one or more processors 204 may execute instructions causing the display data to be presented at the display component 202.

In some embodiments, the display data may be transmitted as electromagnetic waves. For example, in FIG. 3, the ESC apparatus 306 includes the one or more processors 314 that convert the display data into electromagnetic waves, which are transmitted via the wireless connection 312. Furthermore, the display data may be received as electromagnetic waves. For example, in FIG. 4, the computer system 400 includes the one or more processors 404 that convert the electromagnetic waves into a digital format.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

1. A system comprising:
a computer system that includes a display component; and
an apparatus that is physically separate from the computer system and that includes a user input component and a data storage component,
the user input component is configured to receive input that controls what is displayed at the display component,
the computer system is configured to retrieve, from the data storage component, information to be displayed at the display component, and
the computer system will continue to operate if the apparatus is disconnected from the computer system.

2. The system of claim 1, wherein the display component is a head-mounted display component.

3. The system of claim 1, wherein the computer system and the apparatus are communicatively coupled based on a wireless connection.

4. The system of claim 1, wherein the computer system and the apparatus are communicatively coupled based on a wired connection.

5. The system of claim 1, wherein the computer system is a battery based computing device.

6. The system of claim 1, wherein the computer system includes an operating system for managing the display component, the user input component, and the data storage component.

7. The system of claim 1, wherein the data storage component is configured to provide haptic feedback based on a haptic feedback engine or moving parts of the data storage component.

8. An apparatus comprising:
a user input component configured to control another apparatus physically separate and independently movable from the apparatus during operation; and
a data storage component coupled to the user input component and configured to store information received from the another apparatus, the another apparatus including an operating system for running the user input component and the data storage component.

9. The apparatus of claim 8, wherein the user input component includes a touchpad for controlling the another apparatus.

10. The apparatus of claim 8, wherein the user input component includes a microphone for controlling the another apparatus.

11. The apparatus of claim 8, wherein the user input component includes an analog stick or button for controlling the another apparatus.

12. The apparatus of claim 8, wherein the user input component includes a gyroscope for controlling the another apparatus.

13. The apparatus of claim 8, wherein the data storage component includes a magnetic storage.

14. The apparatus of claim 8, wherein the data storage component includes a solid-state storage.

15. An apparatus comprising:
a user input component configured to control a computer system that is physically separate and physically uncoupled from the apparatus; and
a data storage component configured to provide information for display at the computer system, the user input component and the data storage component mounted within a hand-held enclosure and wirelessly connected to the computer system.

16. The apparatus of claim 15, wherein the computer system is mounted on a headset.

17. The apparatus of claim 15, wherein the hand-held enclosure does not include a display component.

18. The apparatus of claim 15, wherein the data storage component provides supplemental storage for the computer system.

19. The apparatus of claim 15, wherein the data storage component includes a magnetic recording device or a solid state recording device.

20. The apparatus of claim 15, further comprising an operating system for managing the user input component and the data storage component.
